(19) United States
(12) Patent Application Publication
(10) Pub. No.: US 2008/0008972 A1
(43) Pub. Date: Jan. 10, 2008

(54) Method for Automatically Generating at Least One of a Mask Layout and an Illumination Pixel Pattern of an Imaging System

(76) Inventors: Thomas Muelders, Dresden (DE); Bernd Kuechler, Dresden (DE); Frank-Michael Kamm, Dresden (DE)

Correspondence Address: SLATER & MATSIL, L.L.P., 17950 PRESTON ROAD, SUITE 1000, DALLAS, TX, 75252, US

(21) Appl. No.: 11/740,150

(22) Filed: Apr. 25, 2007

Related U.S. Application Data
(63) Continuation-in-part of application No. 11/483,254, filed on Jul. 6, 2006.

(51) Int. Cl. G03C 5/00

(52) U.S. Cl. 430/346

(57) ABSTRACT

A method and device can be used for automatically generating at least one of a mask layout and an illumination pixel pattern of an imaging system in a process for the manufacturing of a semiconductor device. The mask layout is subdivided into a multitude of discrete tiles. A first dataset is generated and includes amplitude point spread function (APSF) values for a given imaging system for at least one defocus value z. A second dataset is generated and includes tile spread functions Vq(r), corresponding to mask tiles and illumination pixels. An intensity distribution I(r) is optimized in an image plane for the semiconductor device subject to a merit function by means of a stochastic variation by at least one of the group of the discrete mask tiles and the illumination pixels using the pre-calculated tile spread functions Vq(r) of the second dataset.

This application is a continuation-in-part of U.S. patent application Ser. No. 11/483,254, entitled “Method for Automatically Generating at Least One of a Mask Layout and an Illumination Pixel Pattern of an Imaging System,” filed on Jul. 6, 2006 and which is incorporated herein by reference.

### TECHNICAL FIELD

The present invention relates, in particular embodiments, to a method for automatically generating at least one of a mask layout and an illumination pixel pattern of an imaging system.

### BACKGROUND

Semiconductor manufacturing, especially chip manufacturing relies to a large extent on photolithography techniques to transfer the chip structures from a mask onto a wafer. A key factor for the technical and economical success in chip manufacturing is the achievable spatial resolution of the lithographically printed chip structures. Not only physical characteristics like “memory access times” or the achievable “clock frequency” force the chip manufacturers to continuously shrink the feature sizes, economical reasons are a main driver for the ongoing miniaturization, too. Two facts are responsible for this.

First, smaller structural feature sizes inside a chip are a prerequisite for a reduced chip size and an increased number of chips per wafer.

Second, the number of chips per wafer is a direct measure for the chip throughput, and thus, a measure of productivity. Productivity improvement is a main driver for the ongoing feature size reduction.

In optical lithography, three parameters influence the critical dimension (CD) which represents the smallest structural width on a chip layer and which characterizes the spatial resolution:

$$CD = {k}_{1} \frac{λ}{NA} \qquad ( 1 )$$

λ is the wave length of the exposure light, NA denotes the numerical aperture of the lithographical projection system and k₁ is a process-related factor comprising all other influences except for NA and A. Equation (1) states that the CD can be decreased by employing either a smaller wave length of the exposure light or by increasing the numerical aperture of the projection system. These two possibilities of CD-reduction require enormous technical and financial efforts.

Thus, any other possibility of CD shrink is in great demand. Those types of techniques are called resolution enhancement techniques (RET) which allow a CD shrink without affecting either the numerical aperture or the wave length. The success of RETs in the last 20 years is reflected by the evermore decreasing k1 factor.

While in 1985 k₁≧0.75, nowadays k₁ factors as small as 0.3-0.35 are used in production. In order to achieve such small k₁ factors, optimization of the illumination and/or the mask becomes necessary. It is known that the k₁ factor can be reduced by employing oblique illumination techniques and by adjusting the mask layout to achieve an improved lithographical printing result. Highly specialized optimization software exists to optimize either the mask or the source. However, due to the huge number of degrees of freedom for mask and source adjustments and the rapidly increasing computational complexity with increasing number of adjustable parameters, simultaneously optimizing the mask layout and the source has remained a challenge. It is the enormous size of the parameter space wherein an optimum solution for the mask and source is to be found that causes most optimization software to be either restricted to a subspace (either only mask or only source optimization) or to resort to local optimization schemes that explore only the immediate vicinity in parameter space around initially given mask and source proposals.

Therefore, the generation of masks and illumination sources for a specific task is complex.

Despite the computational complexity, the problem of co-optimizing mask and source layouts has recently been tackled. An important property of any mask-source co-optimization algorithm is the speed of the computation of the intensity distribution corresponding to a single mask-source combination. The reason is that during the optimization many intensity computations for different masks and sources are to be performed in order to find numerically an optimum solution. Due to the huge number of possibilities, a fast intensity computation is a prerequisite for the exploration of a relevant part of the parameter space in acceptable times.

Another problem occurs in the design of masks for which three dimensional evaluations are necessary. This is particularly important for EUV masks because the thickness of the mask layers (ca. 100 nm) is large compared to the wavelength (ca 10 nm). This is further complicated by the fact that the illumination is effected under an angle of 5° to 6° causing shadowing effects. The shadowing effects result in a characteristic distortion of the near-field intensity of the mask (e.g., asymmetrical aerial image, lateral shift of the imaged structure depending on the orientation). The computational load for the complete three dimensional computation of the electromagnetic field is large.

The technological background has been described mainly in connection with memory chips, as, e.g., DRAM chips. This background also applies to the manufacturing of microprocessors and microelectromechanical devices.

### SUMMARY OF THE INVENTION

An embodiment of the invention is concerned with methods and devices reducing the computational load in the field of the manufacturing of semiconductor devices. Furthermore an embodiment of the invention is concerned with the uses of such methods and devices and the mask layouts and illumination patterns generated therewith.

One method and device according to an embodiment of the invention automatically generates a mask layout and an illumination pixel pattern, of an imaging system in a process for the manufacturing of a semiconductor device, wherein the mask layout is subdivided into a multitude of discrete tiles. A first dataset is generated and includes amplitude point spread function (APSF) values for a given imaging system for at least one defocus value z. After splitting the illumination pixel pattern into qₖ pixels, a second dataset is generated and includes tile spread functions V_{q}(r), corresponding to mask tiles and illumination pixels. An intensity distribution I(r) is optimized in an image plane for the semiconductor device subject to a merit function, by means of a stochastic variation by one of the group of the discrete mask tiles and the illumination pixels using the pre-calculated tile spread functions V_{q}(r) of the second dataset.

It is also possible to reduce the computational load with a method, wherein an effective two-dimensional mask-layout is generated based on geometrical optical relationships.

Both methods allow a better computational handling of the mask design.

### BRIEF DESCRIPTION OF THE DRAWINGS

Other objects and advantages of embodiments of the invention become apparent upon reading of the detailed description of the invention, and the appended claims provided below, and upon reference to the drawings.

FIG. 1 shows a general (non-periodic) mask layout consisting of areas with different complex mask transmission values Fᵢ;

FIG. 2 shows a partitioning of a mask feature into tiles;

FIG. 3 shows a single tile on a grid;

FIG. 4 shows the illumination pupil discretized into a grid;

FIG. 5 shows schematically the setup for a mask, an imaging system and an imaging plane;

FIG. 6 shows schematically a symmetrical illumination source;

FIG. 7 shows an embodiment for a co-optimization for rectangular mask tiles;

FIG. 8 shows the results of a simulated annealing simulation for an example test run;

FIG. 9 shows an example of an optimized contact hole image and evaluation points;

FIG. 10 shows the final mask pattern for the example;

FIG. 11 shows the final illumination source pattern for the example;

FIG. 12 shows the normalized image intensity for the example;

FIG. 13 shows the top-down view of the normalized image intensity for the example;

FIG. 14 shows the exposure latitude for best focus for the example; exposure latitude of the contact hole shape for 0 and ±10% variation of the intensity threshold;

FIG. 15 shows the exposure latitude for 100 nm defocus; exposure latitude of the contact hole shape for 0 and ±10% variation of the intensity threshold;

FIG. 16 shows the principle of an EUV mask;

FIG. 17 shows the generation of a generation of an effective two dimensional mask with an embodiment of the present invention; and

FIG. 18 shows schematically the embodiment of a hardware device.

### DETAILED DESCRIPTION OF ILLUSTRATIVE EMBODIMENTS

A new method is presented that allows to simultaneously optimize both, the mask layout and the illumination source shape for lithographical projection printing. The new approach is particularly tailored for the co-optimization of illumination sources and non-periodical mask features. For example, this concerns nearly isolated mask patterns as well as periphery structures in DRAM products.

The new optimization scheme is based on the fast computation of the image intensity change corresponding to a “flipped” mask or source area. The method can be used to optimize the mask layout, the illumination source or the mask layout together with the illumination source. The new approach is demonstrated with a typical example.

As an example, the new and fast computational method described optimizes, in parallel, the mask as well as the illumination source. The new method is not restricted to periodical masks. In the present work, the imaging formalism is transferred into a form particularly suited for a global optimization scheme like simulated annealing where discrete mask areas (“tiles”) and illuminations pixels are to be varied during the optimization.

The optimization scheme acts on the assumption that the mask as well as the source can be partitioned into small discrete areas. In order to set up the notation and to clarify the way of partitioning, this section describes the partitioning and finally introduces the partially coherent imaging equations in terms of a partitioned mask and source.

Partitioning of the Mask into “Tiles”

For the embodiments of the invention the mask topography is considered to be very thin such that it can be characterized by a complex transmission function F(rₒ) where rₒ denotes the position of the tiles on the mask. The transmission function acts like a filter on the electrical field of the incoming exposure light. If the electrical field component immediately in front of the mask at position rₒ is denoted by A, the field component directly behind the mask at the same mask position is given by F(rₒ)×A.

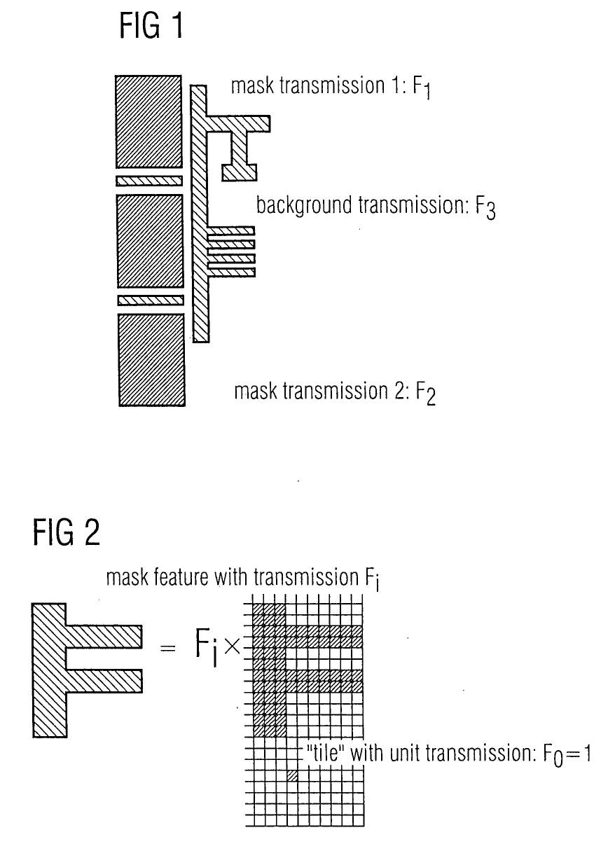

Now, consider a mask layout made up of areas with different (complex) transmission values, see FIG. 1. Any structural feature with transmission value Fᵢ can be represented (at least approximately) as a combination of discrete building blocks.

These building blocks will be called “tiles” as will be described in connection with FIG. 2 in more detail.

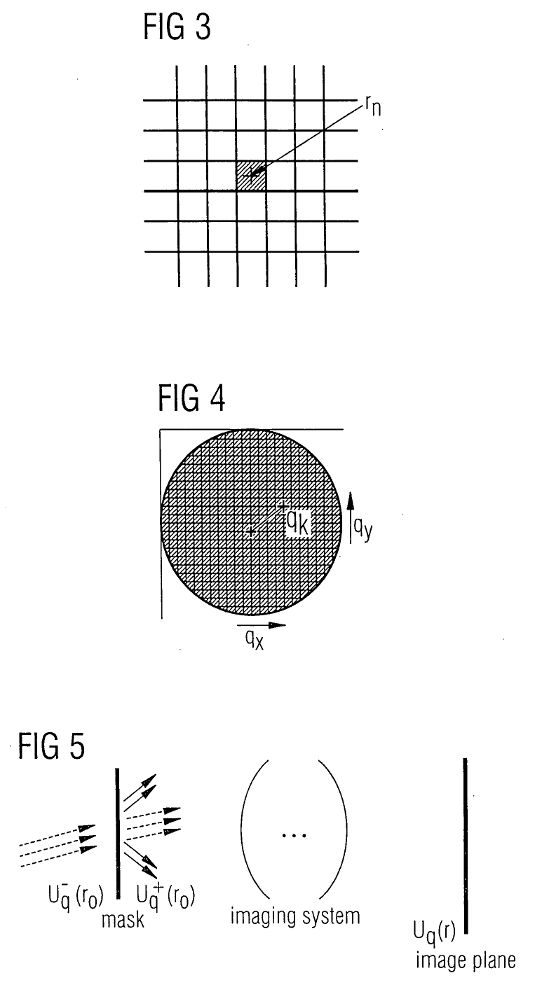

In FIG. 2 the partitioning of a mask feature into “tiles” is depicted. A mask feature with transmission Fᵢ is decomposed into “tiles,” which are small mask units with transmission F₀=1. If the feature transmission Fᵢ does not equal the unit transmission F₀=1 the feature partitioning into tiles must be supplemented by a multiplication with the respective transmission value Fᵢ. The tiles are centered at positions, which are shown in FIG. 3. The center coordinate rₙ of the tile in FIG. 3 does not coincide with the grid points.

Accordingly any mask feature can be represented as a sum of unit “tiles” with transmission F₀=1 multiplied by the respective transmission filter Fᵢ, (i=1, 2 . . . ). The tiles need not necessarily be squares or rectangular area elements. One possible condition is that they can be used to fill a given mask feature completely. For instance, tiles with the geometry of hexagons could be used as well. However, rectangular tiles are particularly simple. For mask optimization purposes they allow easily to include mask fabrication constraints as they are often specified, e.g., for minimum distances between different mask patterns.

An arbitrary mask can be characterized by a transmission function F(rₒ) where rₒ denotes the mask positions. The optimization algorithm to be described in this work presumes that the transmission function F(rₒ) can be decomposed into discrete transmission tiles which are located at discrete mask positions rₙ according to:

$$F ( {r}_{0} ) = \sum {F}_{i} \times g ( {r}_{0} - {r}_{n} ) \\ for \\ i = 1 , 2 , … , n \qquad ( 2 )$$

where Fᵢ denotes one of the possible transmission filter values and g(r) is a function characteristic for the respective tile geometry. For rectangular tiles with side lengths a and b, the tile function g(r) is given by a two-dimensional rect-function:

$$\begin{matrix}g ( r ) = {rect}_{2} ( x / a , y / b ) ≡ rect ( x / a ) \cdot rect ( y / b ) , & ( 3 ) \\ where r = ( x , y ) \\ and \\ rect ( ξ ) = \{ \begin{matrix}1 , & for - 1 / 2 < ξ ≦ 1 / 2 , \\ 0 , & else .\end{matrix} & ( 4 )\end{matrix}$$

The tile function g(r) is defined with respect to the center position of the tiles. Please note that a tile's center position does not coincide with the grid points, see FIG. 3. The set of possible transmission values Fᵢ depends on the mask technology used. For example, alternating phase shifting masks define another set of possible transmission filter values than chrome-on-glass masks.

Partitioning of the Illumination Pupil Into Pixels

Similarly to the partitioning of the mask, the source can be split into several pixels. In FIG. 4 it is shown that the illumination pupil can be represented on a grid. Each point q with q²≧1 in the illumination pupil corresponds to a particular direction of the light with respect to the mask normal. For a sufficiently fine grid any point in the illumination pupil can be approximated by a grid point qₖ.

If the grid in the illumination pupil is sufficiently fine, any illumination direction, i.e., any point q in the illumination pupil, can be approximated by one of the discrete grid points qₖ=(qₓ^{(k)},q_{y}^{(k)}) in the illumination pupil.

Partially Coherent Imaging Using Mask Tiles and Illumination Pixels

Now it will be shown how the equations describing partially coherent imaging can be formulated in terms of mask tiles and illumination pixels. In the next section, the imaging equations formulated in terms of mask tiles and illumination pixels will be used to set up the algorithm for co-optimizing mask and source. To keep the notation short, the equations will be restricted to the scalar imaging equations. The generalization to the vectorial case is straightforward.

For a coherently illuminated mask (q=0) with unit amplitude and zero phase disturbance the field disturbance reads

U0+(ro)=F(ro) immediately behind the mask as shown in FIG. 5. FIG. 5 schematically shows the imaging system illuminated from a particular direction q. The field immediately in front of the mask is denoted by Uq−(ro), while the one directly behind the mask is labeled by Uq+(ro). The field in the image plane is Uq(r).

The (scalar) electrical field at the image point r is then given by the convolution with the amplitude point spread function APSF,

$${U}_{0} ( r ) = \int {\int }_{Mask} {d}^{2} {r}_{0}^{′} {U}_{0}^{+} ( {r}_{0}^{′} ) APSF ( r - {r}_{0}^{′} ) .$$

It has been assumed that the so-called isoplanasy assumption holds stating that the amplitude point spread function depends only on the distances r−rₒ. Real imaging systems scale down the mask features by a factor 4 to 5. Here and in the following, the mask coordinates are represented on a wafer scale, i.e., mask coordinates rₒ in the formulas are considered to be reduced by the respective factor.

The amplitude point spread function characterizes the imaging properties of the projection system. The APSF can be precomputed and forms a first dataset in an embodiment of the invention.

For Kohler illumination, each point in the illumination source q corresponds to a plane wave illuminating the mask. Then the (scalar) field immediately in front of the mask corresponding to a single source point reads at the mask position rₒ:

$$\begin{matrix}{U}_{q}^{-} ( {r}_{o} ) = exp ( - 2 πi \frac{NA}{λ} q \cdot {r}_{o} ) , \\ and & ( 5 ) \\ {U}_{q}^{+} ( {r}_{o} ) = F ( {r}_{0} ) exp ( - 2 πi \frac{NA}{λ} q \cdot {r}_{o} ) , & ( 6 )\end{matrix}$$

denotes the field directly behind the mask. The expression:

$${U}_{q} ( r ) = \int {\int }_{mask} {d}^{2} {r}_{o} \underbrace{F ( {r}_{o} ) exp ( - 2 πi \frac{NA}{λ} q \cdot {r}_{o} )}_{{U}_{q}^{+} ( {r}_{o} )} APSF ( r - {r}_{o} ) , \qquad ( 7 )$$

is the generalization of coherent imaging with q=0 for the oblique illumination (q≠0).

The source is parameterized by the illumination directions I(r) at the image position r is given by:

$$I ( r ) ∝ \int {\int }_{{\vert q \vert}^{2} ≦ t} {d}^{2} q \tilde{w} ( q ) {\vert \underbrace{\int {\int }_{mask} {d}^{2} {r}_{o} F ( {r}_{o} ) exp ( - 2 πi \frac{NA}{λ} q \cdot {r}_{o} ) APSF ( r - {r}_{o} )}_{{U}_{q} ( r )} \vert}^{2} . \qquad ( 8 )$$

Here, \tilde{w}(q) is the source intensity at the illumination point q.

The properties of the imaging system are comprised in the amplitude point spread function APSF that may include the effect of aberrations (particularly defocus) and pupil apodization. Only in the case of an ideal, aberration- and apodization free imaging system the amplitude point spread function is given by the Fourier transform of a “circle function”

$$\begin{matrix}{APSF}_{id} ( {r}^{′} ) = \int \int {d}^{2} α circ ( α ) exp ( - 2 πi \frac{NA}{λ} α \cdot {r}^{′} ) , & ( 9 ) \\ where circ ( α ) = \{ \begin{matrix}1 , & for {\vert α \vert}^{1} ≦ 1 , \\ 0 , & else .\end{matrix} & ( 10 )\end{matrix}$$

Otherwise, e.g., for defocused imaging, the integration over the pupil coordinates a of the imaging system requires a general pupil function P(α)≠circ(α) (also the usual demagnification by a factor 4 to 5 in lithography projection systems can be shown to correspond to an apodized illumination pupil) of the imaging system for constructing the corresponding amplitude point spread function:

$$APSF ( {r}^{′} ) = \int \int {d}^{2} α P ( α ) exp ( - 2 πi \frac{NA}{λ} α \cdot {r}^{′} ) . \qquad ( 11 )$$

In the following it will be assumed that the amplitude point spread function can be computed with any required precision.

Approximating the source integration by the sum over illumination pixels qₖ allows to write the intensity formula (8) as:

$$I ( r ) = \frac{1}{N} {\sum }_{k} w ( {q}_{k} ) {\vert \underbrace{\int \int {d}^{2} {r}_{o} F ( {r}_{o} ) exp ( - 2 πi \frac{NA}{λ} {q}_{k} \cdot {r}_{o} ) APSF ( r - {r}_{o} )}_{{U}_{{q}_{k}} ( r )} \vert}^{2} , \qquad ( 12 )$$

where N is a normalization factor, and w(qₖ)=\tilde{w}(qₖ)A(qₖ) is the area-weighted source intensity at the source point qₖ representing the source area A(qₖ). Equation (12) shows how the intensity computation reduces to a sum over illumination pixels. For the following it will be convenient to specify the normalization factor N as the weighted sum of illumination pixels.

$$N = {\sum }_{k} w ( {q}_{k} ) . \qquad ( 13 )$$

This normalization is the so called “source-point-normalization”.

Next, the intensity formula is to be expressed with discrete mask tiles. In order to do so, it is useful to consider the electrical disturbance U_{q}(r) in the image plane (see FIG. 5). On account of equation (2) the field can be expressed as:

$$\begin{matrix}\begin{matrix}{U}_{q} ( r ) = {\sum }_{n} {F}_{n} \int {\int }_{mask} {d}^{2} {r}_{o} exp ( - 2 πi \frac{NA}{λ} q \cdot {r}_{o} ) \\ g ( {r}_{o} - {r}_{n} ) APSF ( r - {r}_{o} ) \\ = {\sum }_{n} {F}_{n} exp ( - 2 πi \frac{NA}{λ} q \cdot {r}_{n} ) \times \int {\int }_{mask} {d}^{2} {r}_{o} exp \\ ( - 2 πi \frac{NA}{λ} q \cdot ( {r}_{o} - {r}_{n} ) ) g ( {r}_{o} - {r}_{n} ) APSF ( r - {r}_{n} - \{ {r}_{o} - {r}_{n} \} ) \\ = {\sum }_{n} {F}_{n} exp ( - 2 πi \frac{NA}{λ} q \cdot {r}_{n} ) {V}_{q} ( r - {r}_{n} ) ,\end{matrix} \\ with & ( 14 ) \\ {V}_{q} ( r ) = \int {\int }_{mask} {d}^{2} {r}^{′} g ( {r}^{′} ) exp ( - 2 πi \frac{NA}{λ} q \cdot {r}^{′} ) APSF ( r - {r}^{′} ) . & ( 15 )\end{matrix}$$

Equation (14) shows that the field, and thus also the intensity I, can be expressed as a sum over discrete mask tiles with transmission values Fₙ.

Additionally, having introduced the function V_{q}(r), which has the meaning of a “tile spread function” for the respective illumination direction q, the effect of the plane wave factors

$$exp ( - 2 πi \frac{NA}{λ} q \cdot {r}_{0} )$$

which depend on the continuous mask coordinates rₒ can be reduced to the discretized factors

$$exp ( - 2 πi \frac{NA}{λ} q \cdot {r}_{n} )$$

depending only on the tile positions rₙ.

The function V_{q}(r) is independent of the tile position but comprises only the effect of the spatial tile extension. It is given as the convolution of the amplitude point spread function APSF with the tile function g(r) multiplied with the plane wave factor

$$exp ( - 2 πi \frac{NA}{λ} q \cdot r ) ,$$

$${V}_{q} ( r ) = APSF ( r ) ⊗ ( g ( r ) exp ( - 2 πi \frac{NA}{λ} q \cdot r ) ) , \qquad ( 16 )$$

where the symbol ‘\hat{×}’ denotes a convolution. The intensity distribution corresponding to partially coherent illumination reads:

$$I ( r ) = \frac{1}{N} {\sum }_{k} w ( {q}_{k} ) {\vert {U}_{{q}_{k}} ( r ) \vert}^{2} , \\ with \\ {U}_{{q}_{k}} ( r ) = {\sum }_{n} {F}_{n} exp ( - 2 πi \frac{NA}{λ} {q}_{k} \cdot {r}_{n} ) {V}_{{q}_{k}} ( r - {r}_{n} ) . \qquad ( 17 )$$

The idea of the present invention is now to compute V_{qk}(r) (see equation (16)) for all illumination directions qk and to store it in look-up tables before the mask-source co-optimization is started. The look-up tables would comprise a second dataset.

As will be shown next, the storage of V_{qk} in look-up tables allows the construction of a numerically very efficient optimization algorithm.

Numerically Efficient Mask and Source Optimization

The introduction of discretized mask and source allows two types of variations to be distinguished during a co-optimization:
tile flipping, i.e., change of the transmission value Fₙ of a single mask tile with the index n,
flipping of an illumination pixel, i.e., change of the illumination weight w(qₖ) of a single illumination pixel with index k.

Tile Flipping

A varied mask due to a transmission filter change of a single tile new:

ΔFₙ=Fₙ^{new}−Fₙ^{old} (18)

requires only a few operations for updating the electrical disturbances Uqk for the different illumination directions qk:

$${U}_{{q}_{k}}^{new} ( r ) = {U}_{{q}_{k}}^{old} ( r ) + {ΔF}_{n} exp ( - 2 πi \frac{NA}{λ} {q}_{k} \cdot {r}_{n} ) {V}_{{q}_{k}} ( r - {r}_{n} ) . \qquad ( 19 )$$

If the illumination source is kept fixed during the optimization, only those electrical disturbances need to be updated that correspond to a non-vanishing illumination weight w(qₖ)>0. Given the prestored V_{qk} the computation of the new value in equation (19) is performed fast.

However, in contrast to the case with fixed illumination, a mask-source co-optimization with variable mask and source requires this updating for all illumination directions qₖ, no matter whether the respective illumination pixel is currently bright (w(qₖ)>0) or dark (w(qₖ)=0). This means that the electrical disturbances U_{qk} corresponding to all possible illumination directions are to be computed.

Since a single tile variation does not affect the normalization factor N as defined in (13), the intensity is to be updated according to:

$${I}^{new} ( r ) = \frac{1}{N} {\sum }_{k} w ( {q}_{k} ) {\vert {U}_{{q}_{k}}^{new} ( r ) \vert}^{2} . \qquad ( 20 )$$

Vectorial- and Parallel Computation

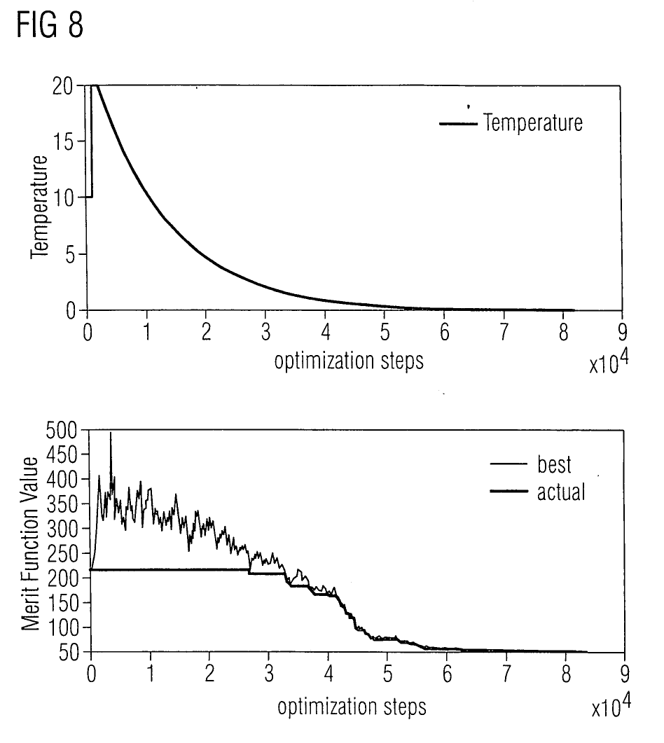

In one embodiment of the invention the algorithm is at least partially parallelized. As will be shown in connection with FIG. 8, the quality of an simulation run, especially the optimization depends in the number of optimization steps. Therefore, the speed of the algorithm is important. One bottleneck in the speeding up of the algorithm is the summation of array fields.

In an embodiment of the invention, the structure of the method is exploited to allow for a vectorial computing.

In one embodiment, the vectorial computation takes advantage of the fact that the new intensity density I_{new}(r):

$${I}_{new} = \frac{1}{N} {\sum }_{k} w ( {q}_{k} ) \cdot {\vert {U}_{qkold} - Δ {U}_{qk} \vert}^{2} \qquad ( 20 a )$$

(see also equation 20) is defined on a matrix r, i.e., the function I can be computed in parallel for each element (pixel) of that matrix r simultaneously. One mask modification requires N r-size summations and 2N r-size multiplications.

One benefit of the vectorization is that one addition for all pixels in r can be achieved in a few clock cycles of a computing machine. Assuming for r an array size of 100 by 100 pixels, a speed improvement of a factor 10000 can be achieved of a serial computation.

In FIG. 18 an embodiment of a hardware device is shown schematically.

The summands in equation 20a are stored in two two-dimensional arrays, array A and array B. For each cell a cell array adder ADD performs the adding step in parallel. In FIG. 18 the adding step is indicated by arrows for an operation on one cell.

The result is stored in a result array C. The result can then be written into array A to perform further computational steps.

The computation can be performed on hardware specifically designed for this application, e.g., application specific integrated circuit (ASIC) or field programmable gate array (FPGA). The computation can also be performed on any hardware consisting of parallel arithmetic logic units (ALU), e.g., vector computer or graphic card.

In another embodiment intermediate results, namely electrical field components of the projected image and components corresponding to different illumination angles are computed in parallel.

Flipping of Illumination Pixels

If the weight of an illumination pixel qₖ is to be changed, w^{new}(qₖ)←w^{old}(qₖ) only the intensity values need to be updated and the numerical effort reduces to:

$$\begin{matrix}{I}^{new} ( r ) = \frac{{N}^{old} {I}^{old} ( r ) + ( {w}^{new} ( {q}_{k} ) - {w}^{old} ( {q}_{k} ) ) {\vert {U}_{{q}_{k}} ( r ) \vert}^{2}}{{N}^{new}} & ( 21 ) \\ with {N}^{new} = {N}^{old} + {w}^{new} ( {q}_{k} ) - {w}^{old} ( {q}_{k} ) . & ( 22 )\end{matrix}$$

### Note that the normalization factor N has to be updated too.

Often the illumination source to be optimized is not completely arbitrary but should fulfill symmetry requirements. Typically, symmetry with respect to the axes qₓ=0 and q_{y}=0 is a minimum requirement since sources that fulfill this requirement prevent a global feature displacement. Another special symmetry requirement appears if all mask structures appear in two orthogonal orientations and if they are to be imaged with the same fidelity. Then the source should fulfill a fourfold symmetry, too. It should not only be symmetrical with respect to the axes qₓ=0, q_{y}=0, but also with respect to the diagonals qₓ=±q_{y}. Then each illumination pixel belongs to a group of 8 pixels, which should have identical illumination weights. (The pixels on any of the symmetry axes have less symmetry partners).

If the source has to fulfill certain symmetry requirements, a single illumination pixel qₖ is to be changed together with its symmetry partners. For instance, an illumination source that is symmetrical with respect to the axes qₓ=0 and q_{y}=0 can be viewed as a set of pixel groups that each contain 4, 2 or 1 members. (If the illumination pixel lies either on the qₓ- or q_{y}-axis the pixel group contains only 2 members. The only exception is the pixel located at qₓ=q_{y}=0 which has no symmetry partners).

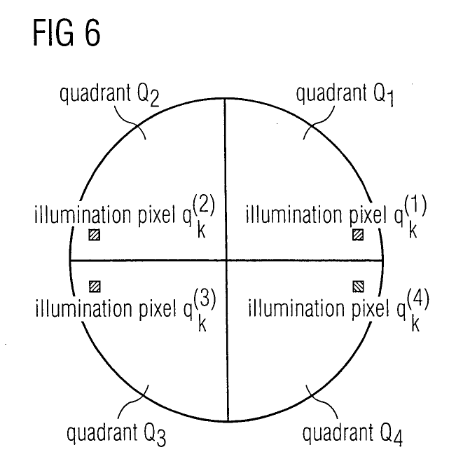

Each such group consists of 4, 2 or 1 pixels each of which being the symmetry partner of one of the other 3 pixels with respect to the axis qₓ=0. The same holds for the other axis of symmetry qₓ=0 (see FIG. 6).

In FIG. 6, an example for a symmetrical source is given. An illumination source that is symmetrical with respect to the qₓ-axis and q_{y}-axis can be partitioned into 4 groups. Each illumination pixel in the first quadrant Q₁ has three symmetry partners in the other three quadrants Q₂, Q₃, Q₄.

The symmetry partners of a single illumination pixel have always the same illumination weights. Illumination pixels, which are linked by symmetry in that way, are therefore to be flipped simultaneously. The intensity updating with groups of P symmetry partners in the illumination pupil reads then:

$${I}^{new} ( r ) = \frac{\begin{matrix}{N}^{old} {I}^{old} ( r ) + ( {w}^{new} ( {q}_{k} ) - {w}^{old} ( {q}_{k} ) ) \\ ( {\vert {U}_{{q}_{k}^{( 1 )}} ( r ) \vert}^{2} + … + {\vert {U}_{{q}_{k}^{( P )}} ( r ) \vert}^{2} )\end{matrix}}{{N}^{new}}$$

$$with$$

$${N}^{new} = {N}^{old} + P \cdot ( {w}^{new} ( {q}_{k} ) - {w}^{old} ( {q}_{k} ) ) ,$$

where the label (p) at U_{q}_{ₖ}^{(p)}(r) denotes the respective symmetry partner.

Memory Requirements for the Partitioning Into Mask Tiles and Illumination Pixels

As has been shown on the previous pages the recomputation of the intensity and the electrical field components after a “flipping” of a mask tile or an illumination pixel requires only very few numerical operations.

Thus, a co-optimization scheme of the mask and the source that is based on the “flipping” of mask tiles and illumination pixels has the advantage that it is fast. Using mask tiles and illumination pixels, the necessary recomputation of the corresponding intensity distributions (several intensity distributions corresponding to different defocus values can be considered) requires only a minimum of computational effort because only the change in the electrical fields and in the intensity distribution must be recomputed. Furthermore, the initial computation and storage of the “tile spread functions” V_{qk}(r) allows even the numerical effort for the computation of the change in the electrical disturbances to be reduced to a minimum. This makes an optimization program fast, particularly if it is based on iterative variations of the mask and the source. For instance, simulated annealing is such an iterative optimization approach but other optimization methods can be used as well.

For a fast computational co-optimization scheme based on the flipping of mask tiles and illumination pixels, the calculation and the storage of the “tile spread functions” V_{qk} is important.

In order to be as fast as possible, the V_{qk} should be computed only once (for each defocus value). Then, they have to be kept in the computer memory. Depending on the number of defocus values, the size of the mask tiles and the maximum necessary spatial extent of the functions V_{qk}, their storage may require gigabytes of memory. Since computer memory is not unboundedly available, it is advantageous to consider the following symmetry properties of the functions V_{qk}, which reduce the memory requirements.

Symmetry properties of the tile spread functions

The symmetry properties of the “tile spread functions” V_{qk}, depend on the geometrical symmetries of the mask tiles and the symmetry properties of the amplitude point spread function APSF.

In the following it will be assumed that the mask tiles are rectangular mask areas and that the amplitude point spread function has (at least) the same symmetry properties as the tile function g(r). For instance, a rotationally symmetrical amplitude point spread function APSF(r)=APSF(|r|) which depends only on the distance |r| remains also invariant under those symmetry operations r→M(r) that leave rectangular mask tile functions unchanged, g(M(r))=g(r).

The symmetry operations M that leave a rectangular tile function g(r)=rect(x/a)·rect(y/b) invariant, g(M(r))=g(r), are given by the two matrices:

$${M}_{x} = ( \begin{matrix}1 & 0 \\ 0 & - 1\end{matrix} ) , \\ {M}_{y} = ( \begin{matrix}- 1 & 0 \\ 0 & 1\end{matrix} ) ,$$

that describes mirroring at the x- and y-axis, respectively. The matrix M_{xy}=MₓM_{y}=M_{y}Mₓ=−1 describes mirroring at the coordinate origin. The symmetry operations:

r←Mₓ·r, r←M_{y}·r, r←M_{xy}·r

leave a rectangular tile function invariant, g(M.r)=g(r), where M stands for either Mₓ, M_{y} or M_{xy}.

In order to see how computer memory can be saved, it is important to note that if the matrices Mₓ, M_{y}, M_{xy} are applied to an illumination vector q⁽¹⁾=(qₓ⁽¹⁾, q_{y}⁽¹⁾)^{T} inside the first quadrant (qₓ⁽¹⁾,q_{yx}⁽¹⁾≧0) the result lies in the 4th, 2nd and 3rd quadrant of the illumination pupil, respectively (see FIG. 4).

q⁽⁴⁾=Mₓ·q⁽¹⁾,

q⁽²⁾=M_{y}·q⁽¹⁾,

q⁽³⁾=M_{xy}·q⁽¹⁾,

with the symmetry properties of the tile function g(r) and of the APSF can be used to show that the tile spread functions V_{q(2,3,4)} corresponding to illumination directions q^{(2,3,4)} inside the 2nd, 3rd or 4th quadrant can be expressed by using only the tile spread functions V_{q(1)} corresponding to the first quadrant of the illumination pupil:

$$\begin{matrix}{V}_{{q}_{k}^{( 2 )}} ( r ) = \int \int {d}^{2} {r}^{′} g ( {r}^{′} ) exp ( - 2 π i \frac{NA}{λ} {q}_{k}^{( 2 )} \cdot {r}^{′} ) APSF ( r - {r}^{′} ) \\ = \int \int {d}^{2} {r}^{′} g ( {M}_{y} \cdot {r}^{′} ) exp \underbrace{( - 2 πi \frac{NA}{λ} {( {M}_{y} \cdot {q}_{k}^{( 1 )} )}^{T} {r}^{′} )}_{{q}_{k}^{( 1 )} \cdot ( {M}_{y} \cdot {r}^{′} )} \\ APSF ( {M}_{y} \cdot ( r - {r}^{′} ) ) \\ {r}^{″} = {M}_{y} {r}^{′} \\ = - \int \int {d}^{2} {r}^{″} g ( {r}^{″} ) exp ( - 2 πi \frac{NA}{λ} {q}_{k}^{( 1 )} \cdot {r}^{″} ) APSF ( {M}_{y} \cdot r - {r}^{″} ) \\ - {V}_{{q}_{k}^{( 1 )}} ( {M}_{y} \cdot r ) .\end{matrix} \qquad ( 23 )$$

Similarly, one finds the corresponding relations for the other two quadrants of the illumination pupil. The tile spread functions of the quadrants 2, 3 and 4 are related to the first quadrant tile spread function by:

V_{q}_{ₖ}_{⁽²⁾}(r)=−V_{q}_{⁽¹⁾}(M_{y}r),

V_{q}_{ₖ}_{⁽³⁾}(r)=+V_{q}_{ₖ}_{⁽¹⁾}(−r),

V_{q}_{ₖ}_{⁽⁴⁾}(r)=−V_{q}_{ₖ}_{⁽¹⁾}(Mₓr).

A Fast Co-Optimization Scheme

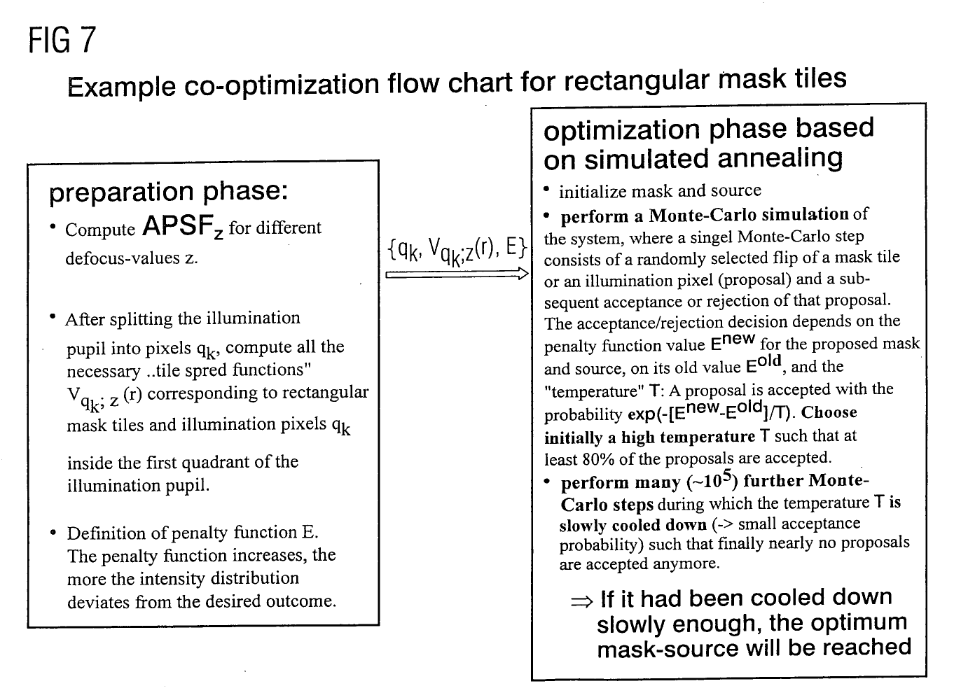

A typical flow chart of a fast co-optimization scheme that is based on the partitioning of the mask into (rectangular) tiles and on the splitting of the illumination pupil into pixels is shown in FIG. 7.

FIG. 7 shows an embodiment for co-optimizing mask and source. The example flow chart applies a simulated annealing scheme and uses rectangular mask tiles. Other optimization schemes are possible as well, but iterative improvement schemes are particularly advantageous.

The optimization (see FIG. 7), requires a merit function to be defined whose values can be utilized as “energy” values E during the simulated annealing algorithm (see equation 23). This merit function should have the property that its values decrease for an improved mask-source pattern. The simulated annealing algorithm aims to minimize the merit function.

Example Optimization

In order to demonstrate the approach of one embodiment of the method a typical example the source together with the mask for an isolated contact hole in chrome-on-glass technology (transmission filter values F₁=0, F₂=1) has been optimized.

The optimization target for width and length of the contact hole has been 120 nm×200 nm. The mask area of 800 nm×800 nm has been partitioned into square tiles each of which having a side length of 20 nm. Both, the mask as well as the illumination source was partitioned into four areas around the origin and were optimized subject to symmetry constraints with respect to mirroring at the horizontal and vertical axis of the mask and source, respectively.

This confined the independent mask tiles to the upper right mask area with size 400 nm×400 nm corresponding to 400 degrees of freedom each of which could be either dark (chrome transmission F₁=0) or bright (glass transmission F₂=0)

The illumination source area grid contained 317 pixels (21 pupil mesh points along a diameter) corresponding to 90 degrees of freedom in the upper right quadrant. Similar to the mask, a source pixel has been assumed to be either bright or dark only.

Thus, the mask-source co-optimization problem together incorporated 490 binary degrees of freedom corresponding to 2⁴⁹⁰≈33.2×10¹⁴⁷ possibilities. A hypothetical supercomputer being able to compute the complete aerial image for that problem in 10⁻⁹ sec would need 3.2×10¹³⁸ sec≈10¹³¹ years to run trough all these possibilities. For comparison, the age of the universe is approximately 10¹⁰ years.

The size of the optimization problem makes clear that a fast intensity computation is required for exploring any relevant part of this huge optimization space.

Apart from a factor which sets the scale, the merit (or “energy”) function E to be minimized has been defined as the sum of three terms:

$$E = {\sum }_{z} {\sum }_{{r}_{h} ∈ H} max \{ 1.3 - I ( {r}_{h} , z ) / τ , 0 \} + {\sum }_{z} {\sum }_{{r}_{l} ∈ L} max \{ I ( {r}_{l} , z ) / τ - 0.7 , 0 \} + {\sum }_{z} {\sum }_{{r}_{equ}} \sqrt{{( I ( {r}_{equ} , z ) / τ - 1 )}^{2}} , \qquad ( 24 )$$

where z denotes a defocus position, I(r, z) stands for the intensity at the image position r in defocus z, and τ is the intensity threshold chosen as the image intensity at the desired edge position x=0, y=60 nm of the contact hole.

The first double sum in (24) runs over those image positions:
rₕ ε H where the desired image intensity is larger than 1.3 times the threshold intensity τ. These are image points inside the contact hole.

The first term contributes only to the “energy” if the intensity at some of these points falls below that limit.

The second term in equation (24) sums over those points where the intensity is to be lower than 0.7 times the threshold intensity, and the second term contributes only to the energy if the intensity at some of these points exceeds 0.7×τ.

The third double sum runs over the desired edge positions r_{equ} of the contact hole. It will always contribute to the energy as long as the intensity at the contact hole edges deviates from the threshold intensity at x=0, y=60 nm.

The merit function definition given by equation (24) is a simple one and can be extended (e.g., using special weights for suppressing side lobe printing).

The described method can be implemented to form a device in the form of software or in the form of a precoded microprocessor. In either case the device would produce a co-optimized mask layout and an illumination source layout.

Results

FIG. 8 shows the temperature T (upper figure) and merit (energy) function E (lower figure) during the simulated annealing optimization. The acceptance probability for a newly proposed mask-source combination is given by min(exp(-(E_{NEW}−E_{OLD})/T,1) resulting in attenuated energy fluctuations for lower temperatures.

After the initial “annealing phase”, the temperature T(n) at optimization step n is continuously cooled down according to T(n)=T₀·α, where T₀ denotes the initial temperature after the annealing phase. α=0.99992 has been used for nₘₐₓ=80000 optimization steps.

It can be seen in FIG. 8 that, while the actual energy during the optimization lies initially above the best energy (incidentally reached during the first mask-source variations), it finally approaches the best energy very closely. That is a typical feature for a simulated annealing optimization where the energy fluctuations become smaller and smaller with decreasing temperature.

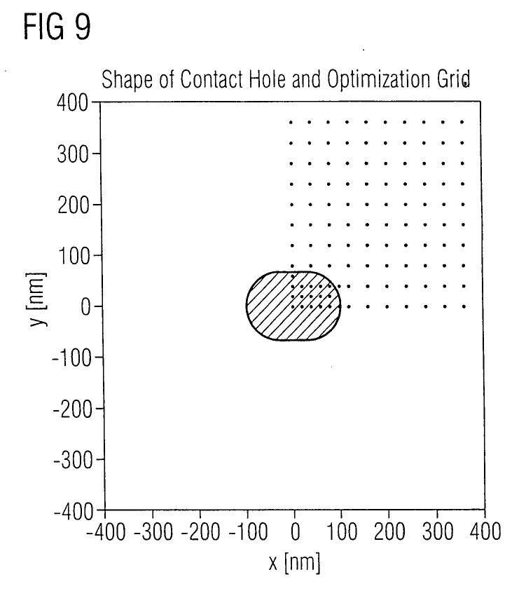

FIG. 9 shows the generated contact hole at best focus together with the intensity evaluation points which have been used to determine the value of the merit function (energy) during the optimization.

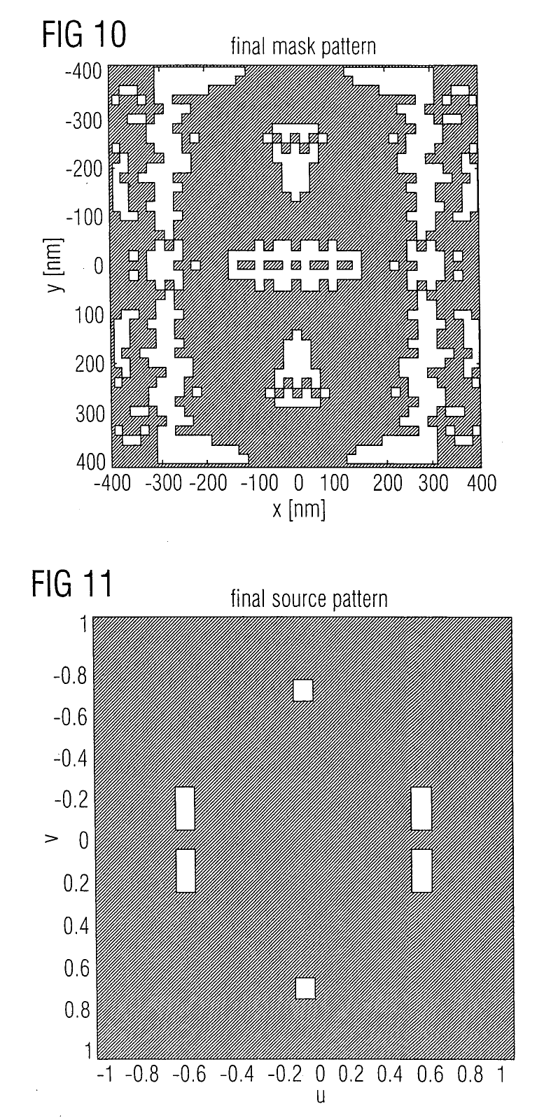

The optimization started with a completely dark mask pattern and a completely bright source for a numerical aperture of NA=0.75. FIGS. 10 and 11 show the finally approached mask and source pattern, respectively.

As can be recognized a complicated mask pattern results contain assist features, which serve to improve the image quality. Of course, this mask pattern should be simplified for actual use in production. However, the geometry of the generated mask pattern is already relatively clear such that a subsequent fine tuning of a simplified mask becomes possible. The source pattern is an asymmetrical quasar illumination that can approximately be realized with only minor simplifications.

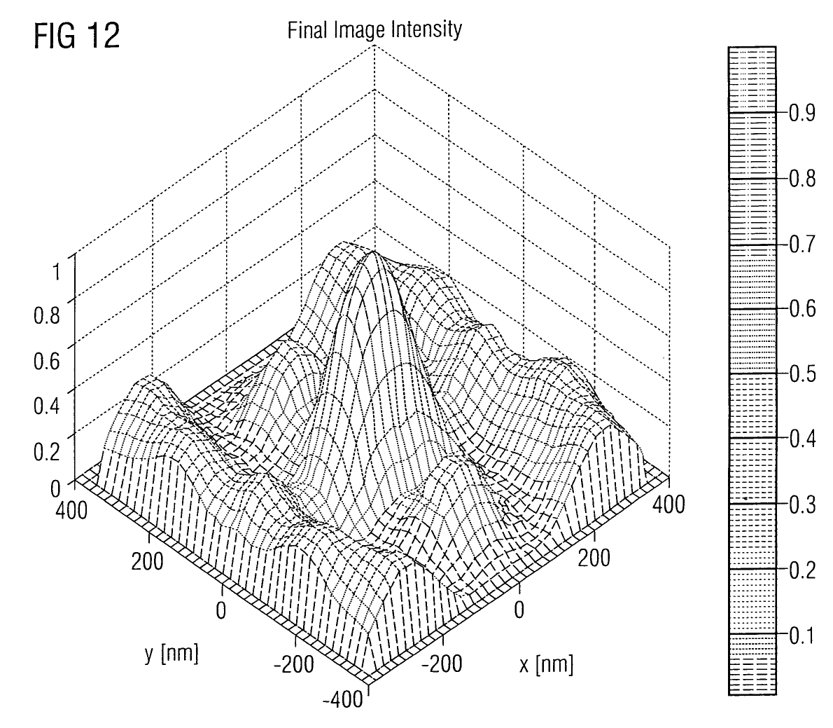

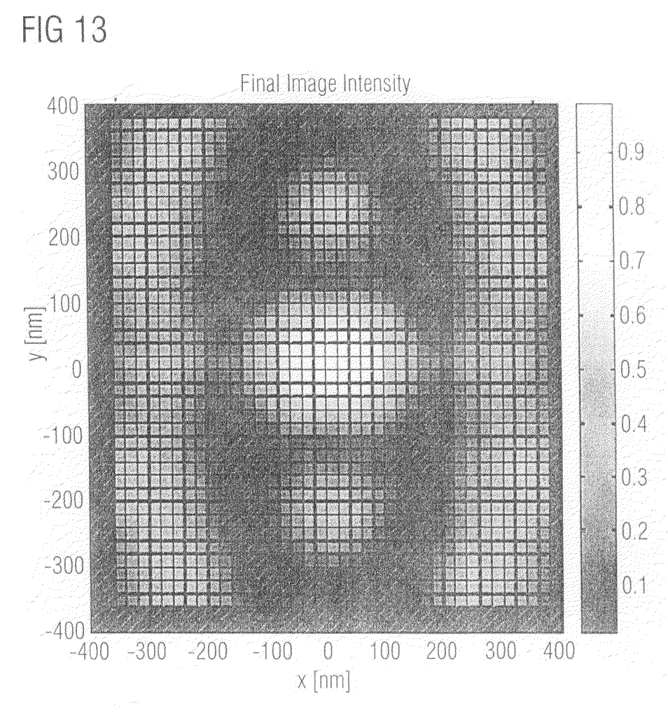

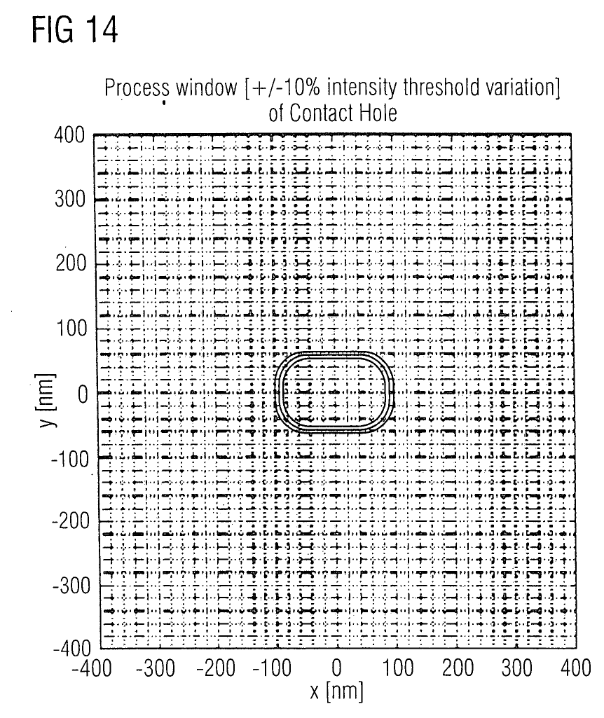

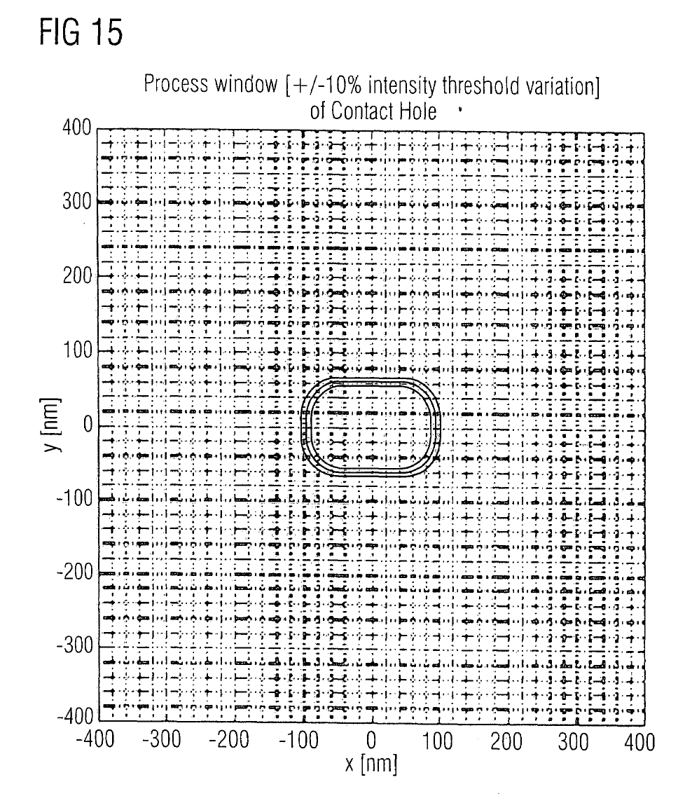

The FIGS. 12 to 15 demonstrate the quality of the obtained optimization result. The image intensity at best focus is depicted in FIGS. 12 and 13. The FIGS. 14 and 15 show contour lines of the isolated contact hole for two defocus positions z=0 (best focus) and z=100 nm at the threshold intensity and at ±10% variation of the intensity threshold. In FIG. 15, for the best focus, the exposure latitude of the contact hole shape for 0 and ±10% variation of the intensity threshold is depicted. In FIG. 15, for a 100 nm, defocus the exposure latitude of the contact hole shape for 0 and ±10% variation of the intensity threshold is depicted.

The method of the present invention uses the flipping of “mask tiles” and “illumination pixels”. The method can be used in a global optimization scheme like “simulated annealing” being able to optimize simultaneously hundreds of degrees of freedom. The reason for this fact is the method's speed, which results because the difference between two aerial image intensities corresponding to different mask-source layouts can be computed quickly if the two layouts differ only in either a single mask tile or a source pixel.

The method has been demonstrated at the co-optimization of mask and source for generating the image shape of an isolated contact hole with dimension 60 nm×100 nm and a numerical aperture of NA=0.75. The optimization results were a mask pattern with assist features and an asymmetrical quasar illumination. In a second step the mask pattern would have to be simplified.

Effective Two Dimensional Mask

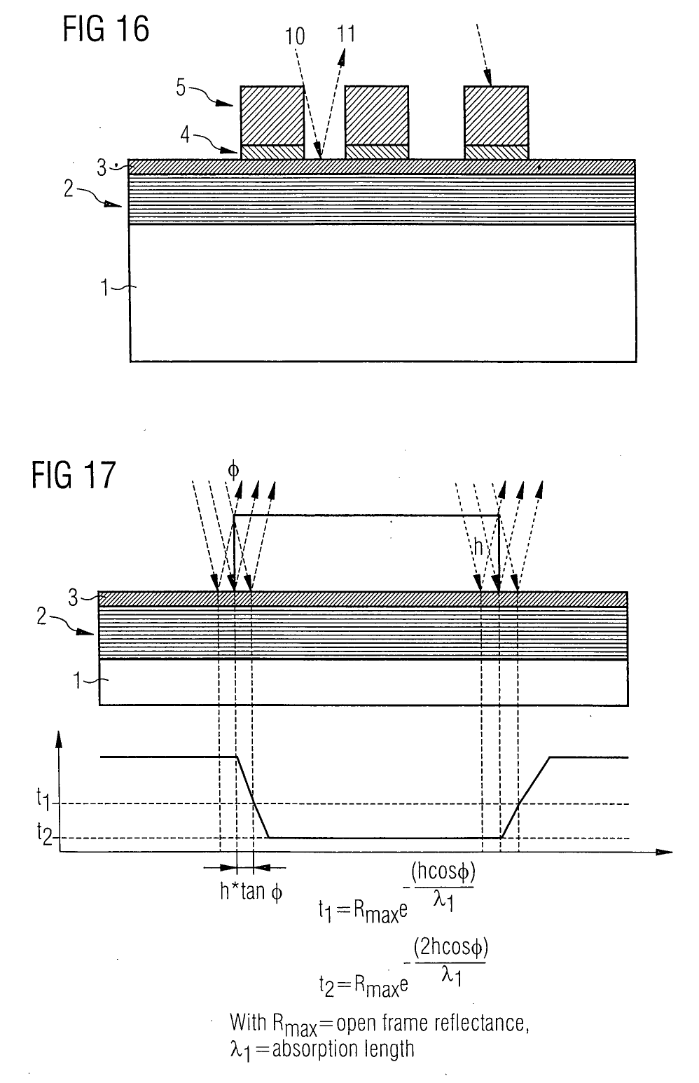

The reduction of the computational load can also be achieved by another embodiment of the invention which is described in connection with FIGS. 16 and 17.

A simple, thin mask model (Kirchhoff-Mask) cannot capture the mask behavior for thicker masks, especially for thicker masks used for EUV (extreme ultraviolet) lithography. The thin mask model is disregarding the complex, three dimensional structures on the mask. Those complex structures generate shadows and displacements and phase transition effects at the pattern edges.

The principle structure of an EUV mask is depicted in FIG. 16. Since this structure is known, it will only be briefly described here.

The EUV mask as such is a reflective mask, i.e., incoming light 10 is reflected by the mask and leaves as reflected light 11. An absorber layer 5 contains the structure on the mask which is to be generated in an imaging plane (not shown here) for the manufacturing of the semiconductor device. Typically the angle of the incoming light 10 relative to the surface of the mask is less than 90°.

Underneath the absorber layer 5, a buffer layer 4 is situated. A reflective multilayer 2 is covered by a capping layer 3, both being situated underneath the buffer layer 4. Those layers are placed on a mask substrate 1.

The same structure is depicted in the upper part of FIG. 17, where the outline of the absorber stack (i.e. absorber+buffer) structure is shown. The incoming light 10 falls under an angle φ on the surface of the mask and is consequently reflected under the same angle.

The edge of the absorber structure in FIG. 17 defines the structure to be printed on the semiconductor device. In a thin mask, the thickness h of the structure would be zero. Now since the mask stack thickness h is considerably large compared to the wavelength in the case shown, an infinitely thin mask is not a good approximation of that edge.

Such an infinitely thin mask would have a transmission function T(x,y)=0 in the dark areas (i.e. underneath the absorber stack pattern) and T(x,y)=1 in the bright areas, where x and y denote the spatial coordinates in the mask plane. Equivalently, the phase part of the complex transmission function would be a step-function as well with a phase of Θ₀ in the bright areas and a phase Θ₀+ΔΘ in the dark areas, describing the phase shift ΔΘ due to the light path through the absorber material.

This simple approach of an infinitely thin mask does not describe the relevant imaging effects of thick EUV masks, like pattern displacement due to oblique incidence of the illumination, asymmetric aerial images, CD changes and asymmetric phase behavior. For this reason, an equivalent thin mask is constructed by generating a complex transmission function that includes the relevant effects.

The construction of the transmission function is done in four steps:

1) A set of reference points and their spatial coordinates are determined. This is done by determining the exit positions on the surface of the absorber stack pattern of reflected beams, reflected with the angle φ. At least three beams are chosen for the reference points:

i) the beam closest to the pattern edge with no absorber material on the path of the incoming and reflected light,

ii) the beam with no absorber material on the path of the incoming beam and with a path length of h/cos φ through the absorber stack for the reflected beam,

iii) the beam with a path length through the absorber stack of h/cos φ for both the incoming and reflected beams.

The respective intersections of those beams with the surface of the absorber stack pattern are the at least three reference points i, ii and iii.

2) The transmission at the at least three reference points is determined. This is done by taking the path length in the absorber material into account and the resulting absorption of this material. The respective transmission values are therefore:

i) Ti=Rₘₐₓ at reference point i, where Rₘₐₓ denotes the reflectance of an unpatterned multilayer stack,

$${T}_{ii} = {R}_{max} \cdot {e}^{\frac{- h}{cos φ \cdot {λ}_{l}}} \qquad ii )$$

at reference point ii, where λₗ is the absorption length of the absorber stack material,

$${T}_{iii} = {R}_{max} \cdot {e}^{\frac{- 2 h}{cos φ \cdot {λ}_{l}}} \qquad iii )$$

at reference point iii.

3) The overall transmission function is constructed by linear interpolation between reference points ii and iii. From reference point i towards the bright part of the pattern, the transmission function remains constant at Rₘₐₓ. Between reference point iii and the respective reference point on the other edge of the pattern, the transmission function remains constant at Tᵢᵢᵢ.

4) The phase part of the complex transmission function is constructed accordingly by using the same reference points as for the transmission function. The phase change at the reference points is calculated by using the relation

$$ΔΘ = \frac{Δ n \cdot l \cdot 2 π}{λ}$$

where Δn is the difference of refractive index between the absorber stack material and vacuum and l is the path length of the light beam traveling through the absorber stack (see 2)), λ is the wavelength of the light.

Using this approximation, an effective two dimensional mask is generated which captures most three dimensional effects but can be numerically handled by two dimensional methods (Fourier transforms, Hopkins Approximation etc.).

If the pattern is symmetric the at least three reference points can be mirrored using the same method, i.e. the transmission function is mirrored at the imaging middle axis.

All embodiments of the invention can be used in the manufacturing of semiconductor devices, such as memory chips, especially DRAM chips, microelectromechanical devices and microprocessors.

What is claimed is:

1. A method for automatically generating a mask layout that can be used in a process for the manufacturing of a semiconductor device, wherein the mask layout is subdivided into a multitude of discrete tiles, the method comprising:
generating a first dataset comprising amplitude point spread function (APSF) values for a given imaging system for at least one defocus value z;
after splitting the illumination pixel pattern into qₖ pixels, generating a second dataset comprising tile spread functions V_{q}(r), corresponding to mask tiles and illumination pixels, wherein r comprises an array;
optimizing an intensity distribution I(r) in an image plane for the semiconductor device subject to a merit function by means of a stochastic variation by at least one of the group of the discrete mask tiles and the illumination pixels using the pre-calculated tile spread functions V_{q}(r) of the second dataset, wherein at least one numerical computation on the array r is executed in parallel;
generating a mask layout using results of the optimizing; and
fabricating a physical device using the mask layout.

2. The method according to claim 1, wherein the tile spread function V_{q}(r) is calculated as a convolution of the ASPF with the tile function g(r) and the plane wave factor:
$${V}_{q} ( r ) = ASPF ( r ) ⊗ ( g ( r ) exp ( - 2 πi \frac{NA}{λ} q \cdot r ) )$$

3. The method according to claim 2, wherein the intensity distribution I(r) is determined by
$$I ( r ) = \frac{1}{N} {\sum }_{k} w ( {q}_{k} ) {\vert {U}_{qk} ( r ) \vert}^{2}$$
$$with$$
$${U}_{qk} ( r ) = \sum {F}_{n} exp ( - 2 πi \frac{NA}{λ} {q}_{k} {r}_{n} ) {V}_{qk} ( r - {r}_{n} )$$
whereas V_{qk} are the precalculated tile spread functions.

4. The method according to claim 1, wherein a lithography mask layout and an illumination pixel pattern is generated.

5. The method according to claim 4, wherein the lithography mask layout and the illumination pixel pattern are optimized concurrently.

6. The method according to claim 1, wherein the discrete tiles of the mask layout comprise at least one spatial symmetry, so that symmetric tiles have the same properties.

7. The method according to claim 1, wherein the illumination pixel pattern comprises at least one spatial symmetry, so that symmetric pixels have the same properties.

8. The method according to claim 1, wherein the mask layout comprises at least partially a periodic pattern.

9. The method according to claim 1, wherein the illumination pixel pattern has at least a partially periodic pattern.

10. The method according to claim 1, wherein the stochastic variation is performed using at least one of the group of simulated annealing method and genetic algorithm.

11. The method according to claim 1, wherein the mask layout is for one of the group of reflective masks, transmission masks and phase shifting masks.

12. The method according to claim 1, wherein the shape of the discrete tiles is one of the group of rectangular, quadratic or hexagonal.

13. The method according to claim 1, wherein an effective two-dimensional mask-layout is generated based on the properties of three light beams defining the transmission of at least three reference points on the mask-layout, the reference points being denoted as i, ii, and iii.

14. The method according to claim 13, wherein at least a second set of at least three reference points is generated symmetrically.

15. The method according to claim 13, wherein the transmission of the three reference points are:
i) Tᵢ=Rₘₐₓ at the reference point i, where Rₘₐₓ denotes the reflectance of an unpatterned multilayer stack,
$${T}_{ii} = {R}_{max} \cdot {e}^{\frac{- h}{cos φ \cdot {λ}_{l}}} \qquad ii )$$
at the reference point ii, where λₗ is the absorption length of the absorber stack material,
$${T}_{iii} = {R}_{max} \cdot {e}^{\frac{- 2 h}{cos φ \cdot {λ}_{l}}} \qquad iii )$$
at the reference point iii.

16. The method according to claim 13, wherein the overall transmission function is constructed by linear interpolation between reference points ii and iii.

17. The method according to claim 16, wherein from reference point i towards a bright part of the pattern, the transmission function remains constant at Rₘₐₓ.

18. The method according to claim 17, wherein between reference point iii and a respective reference point on the other edge of the pattern, a transmission function remains constant at Tᵢᵢᵢ.

19. The method according to claim 13, wherein the phase part of the complex transmission function is constructed by using the same reference points as for the transmission function, the phase change at the reference points being calculated by using the relation
$$ΔΘ = \frac{Δ n \cdot l \cdot 2 π}{λ}$$
where Δn is the difference of refractive index between the absorber stack material and vacuum and l is the path length of the light beam traveling through the absorber stack (see 2) ), λ is the wavelength of the light.

20. The method according to claim 13, wherein the linear function modeling the edge of a structure on the mask layout depends on the incident angle of the lithographic light.

21. The method according to claim 13, wherein the mask layout is one of the group of transmission mask and reflective mask.

22. The method according to claim 1, wherein at least two of the electrical field components U_{qk}(r) of the intensity distribution I(r) on the array r are computed in parallel, wherein I(r) is calculated as:
$$I ( r ) = \frac{1}{N} {\sum }_{k} w ( {q}_{k} ) {\vert {U}_{qk} ( r ) \vert}^{2} .$$

23. The method according to claim 1, wherein the parallel computation execution is performed with a hardware device.

24. The method according to claim 23, wherein the hardware device comprises at least one of an ASIC (application specific integrated circuit), a FPGA (field programmable gate array), a vector machine, a graphic card, or a graphics processing unit.

25. The method according to claim 23, wherein at least two two-dimensional memory arrays and a cell array adder are used for a vectorial computation.

26. The method according to claim 1, wherein the physical device comprises a semiconductor device.

27. The method according to claim 26, wherein the semiconductor device comprises a dynamic random access memory chip, a microprocessor or a microelectromechanical device.

28. The method according to claim 1, wherein the physical device comprises a mask.

29. The method according to claim 28, wherein the mask layout comprises a mask layout for an EUV mask.

30. A method for manufacturing a device, the method comprising:
generating an effective two-dimensional mask-layout based on properties of at least three light beams defining a transmission at three reference points on the mask-layout; and
using the mask-layout to produce a physical device.

31. The method according to claim 30, wherein the physical device comprises a semiconductor device.

32. The method according to claim 31, wherein the semiconductor device comprises a dynamic random access memory chip, a microprocessor or a microelectromechanical device.

33. The method according to claim 30, wherein the physical device comprises a mask.

34. The method according to claim 33, wherein the mask-layout comprises a mask-layout for an EUV mask.

35. The method according to claim 30, wherein at least a second set of at least three reference points is generated symmetrically.

36. The method according to claim 30, wherein the three reference points are denoted as i, ii, and iii, and wherein the transmission of the three reference points are:
i) Tᵢ=Rₘₐₓ at the reference point i, where Rₘₐₓ denotes the reflectance of an unpatterned multilayer stack,
$${T}_{ii} = {R}_{max} \cdot {e}^{\frac{- h}{cos φ \cdot {λ}_{l}}} \qquad ii )$$
at the reference point ii, where λl is the absorption length of the absorber stack material,
$${T}_{iii} = {R}_{max} \cdot {e}^{\frac{- 2 h}{cos φ \cdot {λ}_{l}}} \qquad iii )$$
at the reference point iii.

37. The method according to claim 36, wherein an overall transmission function is constructed by linear interpolation between reference points ii and iii.

38. The method according to claim 37, wherein from reference point i towards a bright part of the pattern, the transmission function remains constant at Rₘₐₓ.

39. The method according to claim 38, wherein between reference point iii and a respective reference point on the other edge of the pattern, the transmission function remains constant at Tᵢᵢᵢ.

40. The method according to claim 30, wherein a phase part of the complex transmission function is constructed by using the same reference points as for the transmission function, the phase change at the reference points being calculated by using the relation
$$ΔΘ = \frac{Δ n \cdot l \cdot 2 π}{λ}$$
where Δn is the difference of refractive index between an absorber stack material and vacuum and l is a path length of the light beam traveling through the absorber stack, λ is the wavelength of the light.

41. The method according to claim 30, wherein a linear function modeling an edge of a structure on the mask layout depends on the incident angle of the lithographic light.

42. The method according to claim 30, wherein the mask-layout is a transmission mask or a reflective mask.
